(19) United States
(12) Patent Application Publication
(10) Pub. No.: US 2011/0270765 A1
(43) Pub. Date: Nov. 3, 2011

(54) Self Dispatching Method for Services

(76) Inventor: John Burdin, Tulsa, OK (US)

(21) Appl. No.: 12/768,888

(22) Filed: Apr. 28, 2010

(51) Int. Cl. G06Q 30/00; G06Q 10/00; G06Q 99/00; G06Q 50/00

(52) U.S. Cl. 705/80; 705/7.19; 705/27.1

(57) ABSTRACT

A method for self dispatching services of tradesmen or other service providers. The invention allows consumers to order services based on the availability of specific servicemen working in the vicinity, based on availability of specific servicemen that the consumer wishes to use, based on urgency or lack of urgency of their service needs, and based on the price which is set by the servicemen based on urgency criteria and availability to do work in a particular area or particular time frame. The present invention also allows servicemen to work more efficiently by grouping their jobs in close proximity in time and area and by allowing them to fill in slow work times with lower urgency, lower priced work. The system allows servicemen to advertise their service and consumers to rate the quality of work they receive from specific servicemen. The invention allows consumers to find real time service by taking advantage of a vendor queue line. The invention allows consumers to keep track of property history, warranties and installed product information.

### BACKGROUND OF THE INVENTION

1. Field of the Invention

The present invention relates to a method for self dispatching services of tradesmen or other service providers such as plumbers, electricians, HVAC servicemen, etc. The present invention allows a consumer to order services based on the availability of servicemen working in the vicinity, based on availability of specific servicemen that the consumer wishes to use, based on the urgency or lack of urgency of their service needs, and based on price which is set by the servicemen based on urgency criteria and availability to do work in a particular area or particular time frame. The present invention also allows servicemen to work more efficiently by grouping their jobs in close proximity in time and area and by allowing them to fill in slow work times with lower urgency and lower priced work. Servicemen can advertise their services on this system and consumers can rate the quality of work they receive from the servicemen so that other consumers can know the type of service that a given serviceman provides.

2. Description of the Related Art

Currently, there is no real way for customers and servicemen to coordinate their activities so that the servicemen are able to have steady work

and work most efficiently while providing the customer with choices in when and by whom their work is to be done and at what price.

The present invention addresses this need by allowing a customer to see the other jobs that have already been scheduled in their area and allowing them to select the urgency for their job at a price that is commensurate with that urgency. Simultaneously, the servicemen benefit by increasing their efficiency since now they can work jobs in a given area before moving to a new area and by prioritizing urgency of jobs based on client input. The present invention also allows workers to fill in their slow times with lower priced, lower priority work and higher priority work when they are available while allowing the customer to benefit from those cost savings on their work that is not so urgent. The invention also allows customers to find next available contractor by viewing a queue of contractors without work in a real time environment allowing customer to skip waiting time and allows vendors to fill in work gaps.

### SUMMARY OF THE INVENTION

The present invention is an internet based method for self dispatching services of tradesmen or other service providers such as plumbers, electricians, HVAC serviceperson, etc. This customer based dispatching method employs a customer based social internet mapping system that allows customers to queue on a map with other customer to get better rates on service. The present invention allows a consumer to order services based on the availability of serviceperson working in the vicinity, based on availability of specific serviceperson that the consumer wishes to use, based on the urgency or lack of urgency of their service needs, and based on price which is set by the serviceperson based on urgency criteria, based on number of service calls in a particular area, and based on the serviceperson's availability to do work in a particular area or particular time frame. The present invention also allows serviceperson to work more efficiently by grouping their jobs in close proximity in time and area and by allowing them to fill in slow work times with lower urgency and lower priced work. Serviceperson can advertise their services on this system and consumers can rate the quality of work they receive from the servicemen so that other consumers can know the type of service that a given serviceperson provides. Serviceperson with no work may enter an emergency queue that allows consumers a real time available vendor. Work orders are tracked by job address this allows consumers to keep track of all service history to property including manufacture warranties and any other important property information.

### BRIEF DESCRIPTION OF THE DRAWINGS

FIG. 1 is flow chart showing a customer process portion of a self dispatching method for services according to a preferred embodiment of the present invention.

FIG. 2 is flow chart showing a vendor process portion of a self dispatching method for services according to a preferred embodiment of the present invention.

FIG. 3 is flow chart showing a customer feedback portion of a self dispatching method for services according to a preferred embodiment of the present invention.

FIG. 4 is an entry computer screen for the self dispatching system showing where the customer logs into the system by entering his zip code.

FIG. 5 is a computer screen for the self dispatching system showing a queue map for the address provided by a customer.

FIG. 6 is a computer screen for the self dispatching system showing a customer order for a particular job being created by a customer with the customer entering information about the job and requesting that they set their own price for the job using a bidding process. Customer also can order for a particular job being created with the customer selecting by vendor pricing, by specific vendor, or by technician rating.

FIG. 7 is a computer screen for the self dispatching system showing a customer order for a particular job being created by a customer with the customer entering information about the job and requesting vendor using the vendor set pricing.

FIG. 8 is a computer screen for the self dispatching system showing a customer order for a particular job being created by a customer with the customer requesting that the work be done on an emergency basis.¹

FIG. 9 is a computer screen for self dispatching system showing a contractor profile which includes contractor vendor advertisement for its services, introduces its service technicians, displays its performance record, and enters the type of work it is available to do and its pricing for different types and urgency of work.

FIG. 10 is a computer screen for self dispatching system showing a technician profile which includes information about the qualifications, experience and performance of the technician and photos of and other information about the technician.

FIG. 14 is a computer screen for self dispatching system that shows

Computer screen that vendor may use to fill out job scenario and pricing.

FIG. 15 is a computer screen for self dispatching system that show What customer can see when choosing vendor from real time standby queue.

### DETAILED DESCRIPTION OF THE PREFERRED EMBODIMENT

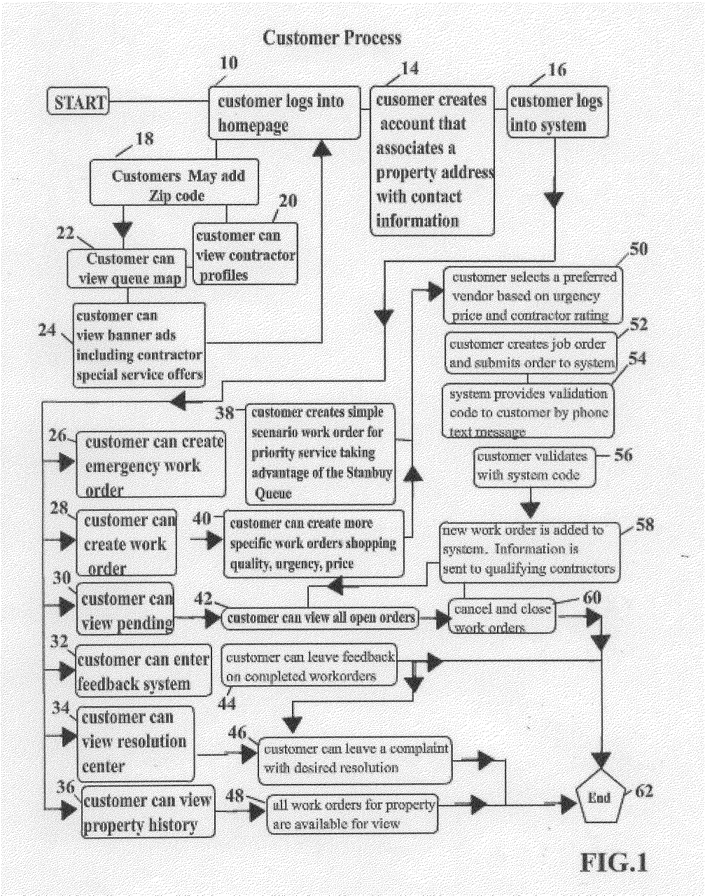

Referring now to the drawings and initially to FIGS. 1-3, there are shown flow charts that detail the present invention which is an internet based method for self dispatching services of tradesmen or other service providers such as plumbers, electricians, HVAC servicemen, etc. The method consist of three distinct subsections or portions: a customer process portion, a vendor process portion and a customer feedback portion.

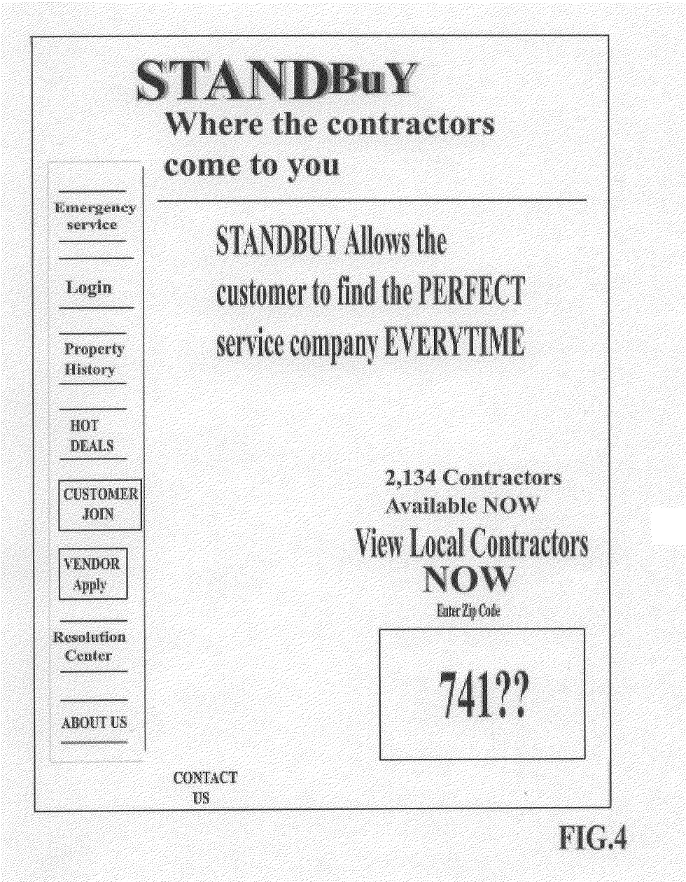

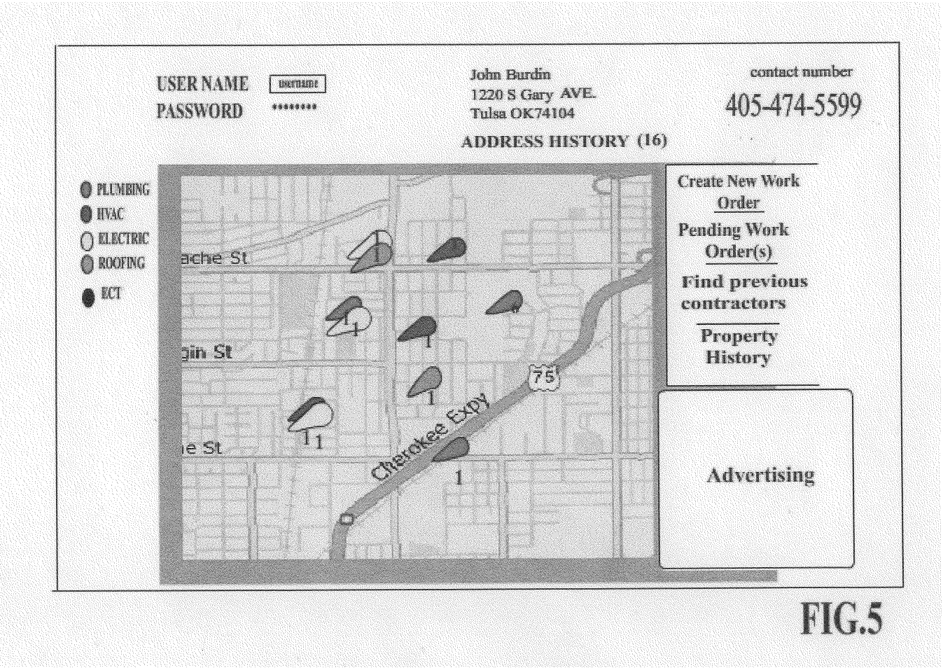

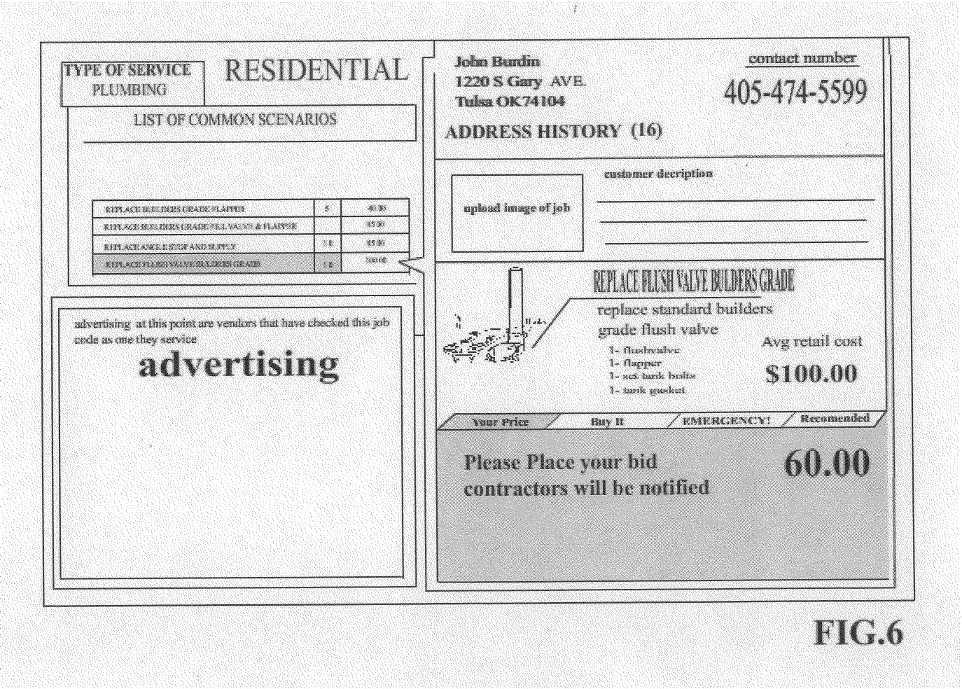

Referring now to FIG. 1, the customer process portion of the method starts at the start box 10 with the customer going to the website on the internet where the self dispatching system is located. The first computer screen that the user sees will look similar to the one shown in FIG. 4.

As shown in box 10 of FIG. 1, the customer can either move to box 18 which allows customer to add their zip code or move to box 14 which allows customer to create a new account or move to box 16 which allows customer to log in to an existing account. Starting with box 18 of FIG. 1. This is a limited area that allows customer to get to know the site and overview features. Customers can navigate boxes 20, 22, 24 without creating an account. Box 22 of figure one will show customer's a map of the service area near the entered zip code. This map will have tags for any service's already contracted by other customer's colored by trade and priority as shown in FIG. 5. Box 20 allows customer's to view vendors profile, scenario prices and all information contractor provides. Box 24 allows customer's to view any advertisements.

Advanced interaction with site will require customer to start at Box 14. Box 14 allows customer to create a property profile that includes all contact information and creating account username and password. Box 16 allows new and existing customer's to log in for the advanced features. The advanced features are boxes 26, 28, 30, 32, 34, and 36.

Box 26 of figure one allows customer's to self dispatch priority service. Box 38 uses simple list of emergency scenario's which customer selects then moves to Box 50. Box 50 will have a list of priority vendors that are waiting in queue without work and are available right as work is contracted. This Queue is exclusive to real time available contractors as shown in FIG. 15. Contractors that contract work through the site or outside of site are required to drop of the queue list when not available. Box 52 creates customer work order and submits order to system. Box 54 submits a validation to customer via contact information and contractor via contact information. Both customer and vendor must approve work order to move it to the pending file. When both sides confirm, the work order it moves to box 42 which is were all pending work orders for customer and vendors will remain till work is completed. Box 60 allows customer an area to close pending work orders which ends this portion of the process.

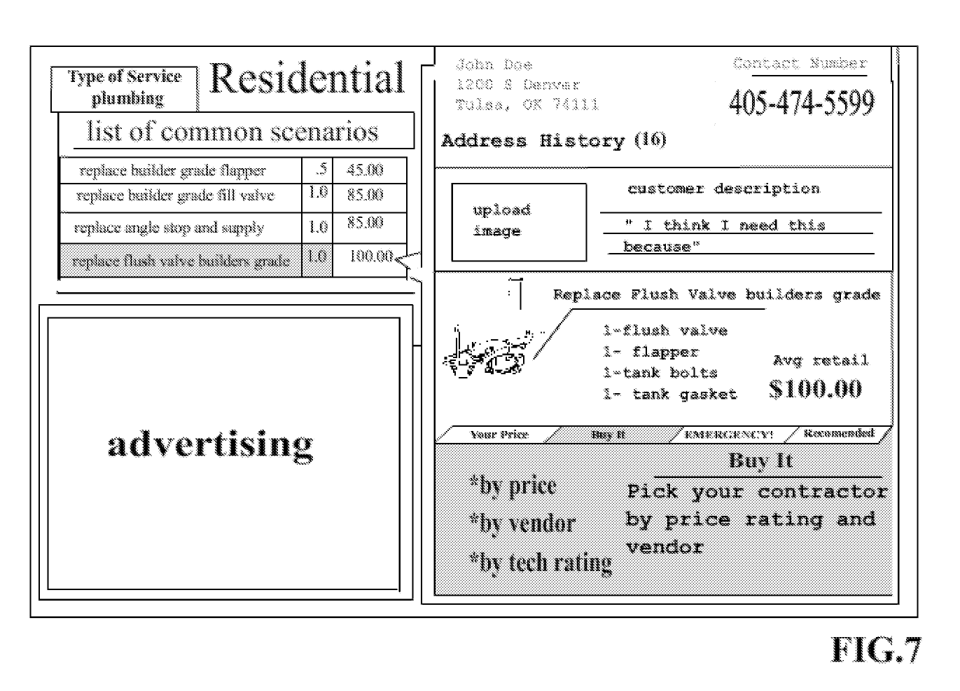

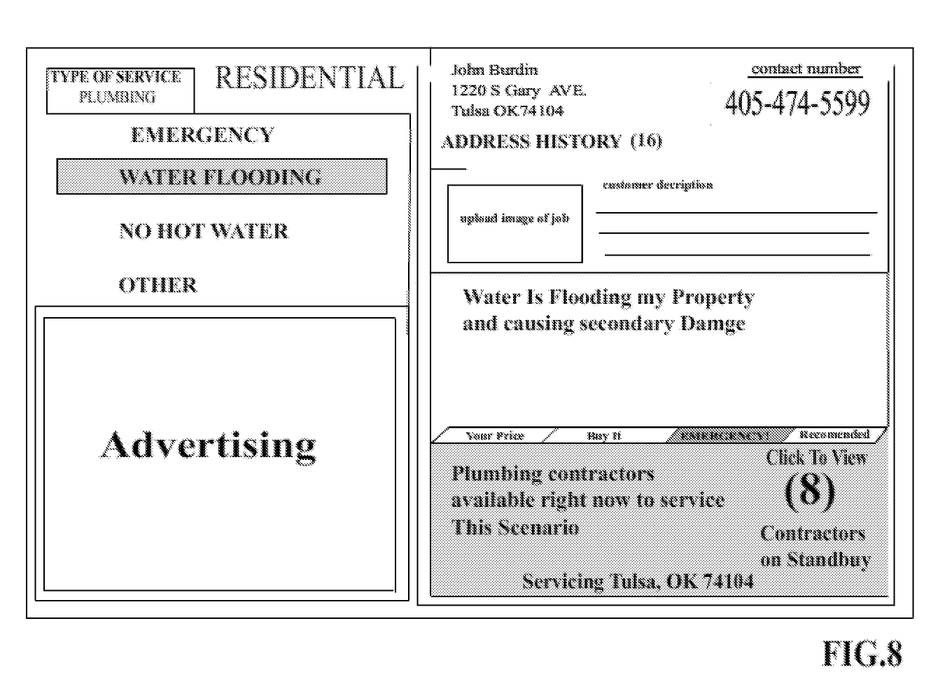

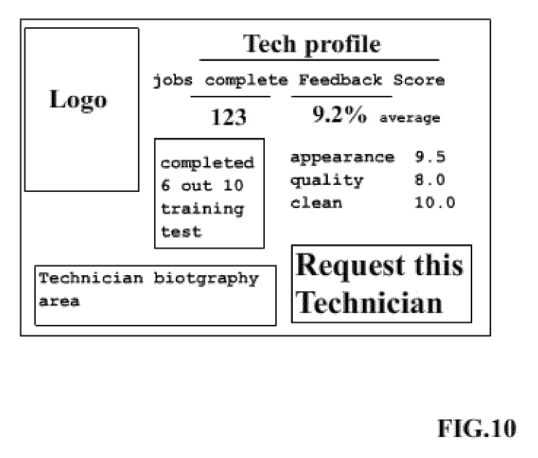

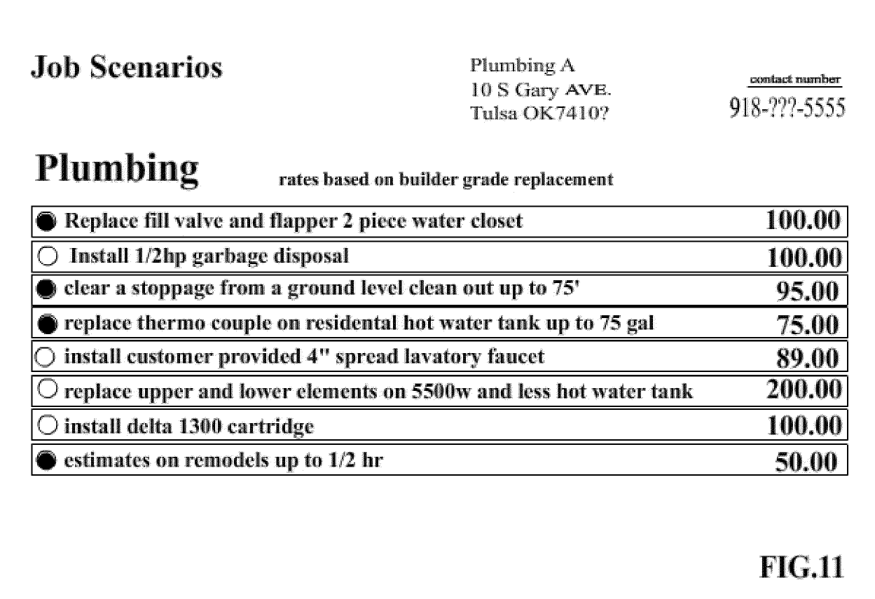

As shown in FIG. 5 box 28 the system will display a queue map for the address provided by the customer. The queue map will display a list of other work orders or services that are scheduled to soon be performed in that area, with key colors and numbers defining the types of services and the urgency of each service displayed on the map. At this point, the customer can either decide to list their required service in the queue by clicking on Create New Work Order on the screen shown in FIG. 5, as described in box 28, or alternately, can click on Advertising on the screen shown in FIG. 5 to optionally obtain additional information on the vendors, contractor profiles, pricing and technician ratings before deciding to list their required service in the queue, as described in box 20. If the customer chose to obtain additional information on the vendors, etc., the computer screens shown in FIGS. 9 and 10 would then be viewed by the user. When the user is ready to list their required service in the queue, as shown in box 50, they would proceed to select the service required from a list of common scenarios or describe their specific service requirements as shown in box 52 and as shown on the computer screen of FIG. 7. On this screen the customer can select a service from the list of common scenarios listed on the left hand side of the screen and/or can upload an image of their particular problem with a description of the problem or provide other information such as model and serial numbers for the equipment involved, etc. Each of the common scenarios will have a pop up screen associated with it that illustrates the equipment involved in that service, as shown in the middle of the right hand side of FIG. 7. Each of the common scenarios includes an estimate of the number of hours required to perform the service and an average cost estimate for completing the work based on builder's standard pricing.

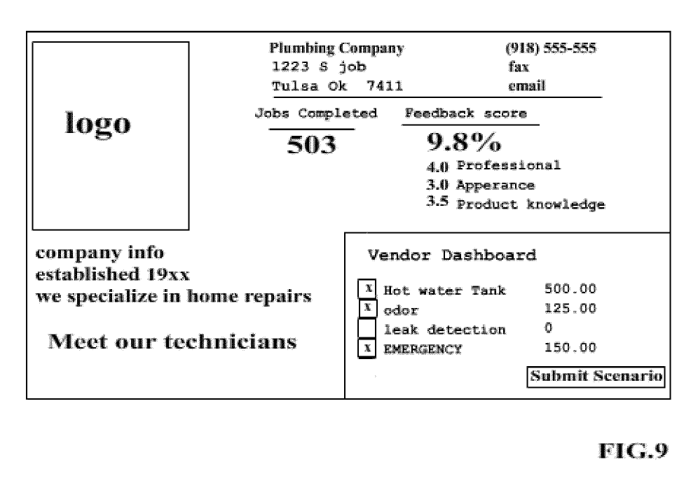

Next, as shown in box 50, the customer selects a level of urgency for the job. As shown in the lower right hand corner of FIG. 8, one option that can be selected for level of urgency is Emergency. When the Emergency level of urgency is selected the customer moves back to Box 26. On the other hand, if the job is not urgent, the customer can select the speed with which their job is to be performed, with the lower urgency jobs receiving a larger discount in pricing and those jobs that are higher in urgency being performed more quickly, but at a higher cost. This selection of pricing and urgency rating is illustrated in the lower right hand corner of FIG. 7. One option is that the customer bid their own price for the job instead of selecting a vendor quoted price. If this option is selected, the customer also selects the quality required and whether they wish to accept counter offers for pricing on the work from vendors.

As shown in box 40, the customer has the option of selecting a preferred vendor or a preferred technician to do the work. Alternately, the customer can select the vendor and technician based on price, urgency, and technician rating. As shown in box 50, after the customer has selected all of the necessary items, they create a job order and submit the order to the system. As described in box 54, the system then provides a validation code to the customer by phone, text message or voice mail. As shown in box 56, the customer must then log into the system to validate the work order using the validation code that was provided to the customer by the system. This step prevents unauthorized orders from being entered into the system. Next, as shown in box 58, upon validation of the work order by the customer, the system displays the new work order in the pending work order section and updates the queue map in FIG. 5. As shown in box 60, this ends the customer process for entering a work order into the system.

Box 42 allows customer to view open Work orders. Customers can move to Box 60 to close open work orders and move them to the feedback section. Box 32 starts the feedback process customer grades contractor on both performance and cost in box 44. If the grade is average or above the feedback is left and the work order moves to history. If vendor grades below average the customer will have the option to move work order to resolution center.

Box 46 Shows resolution area here the customer can file a complaint and request terms for conflict resolution issues. Once an issue is resolved the work order moves to work or address history in Box 36. Box 36 allows customers to see all history for a properties address. These files are saved in box 48 and will allow customers to view all service history at the property. This feature helps keep track of warranty information, product information serials numbers and anything else that pertains to property service history. This ends the history and feedback portion of this process.

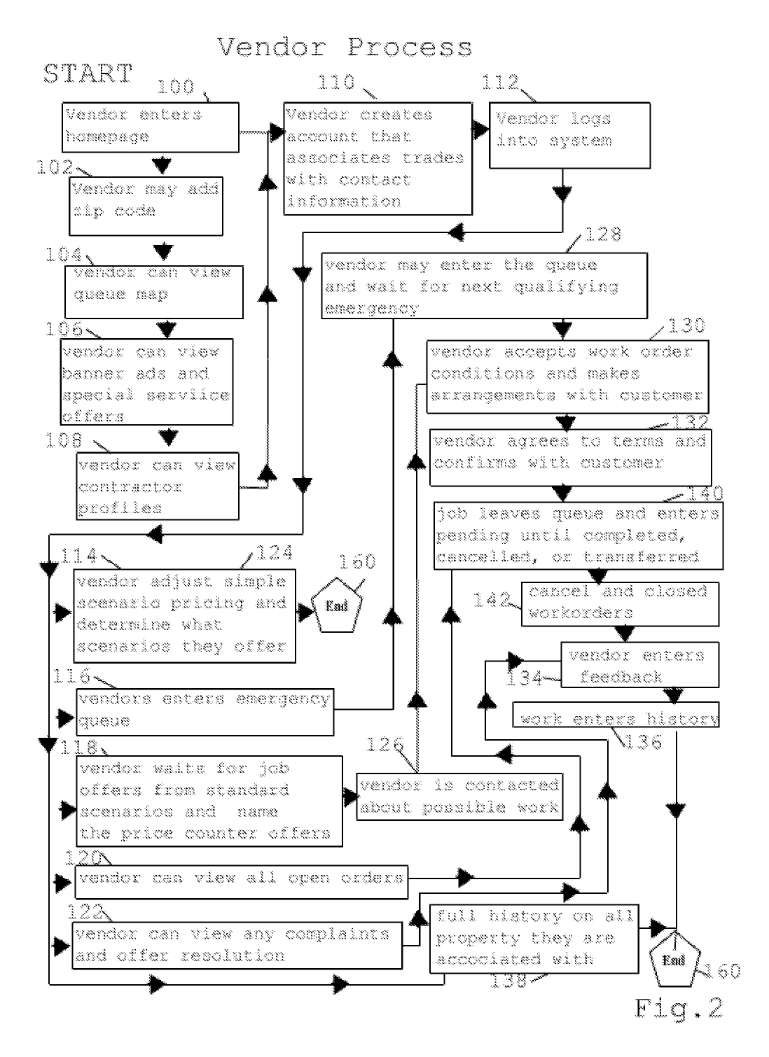

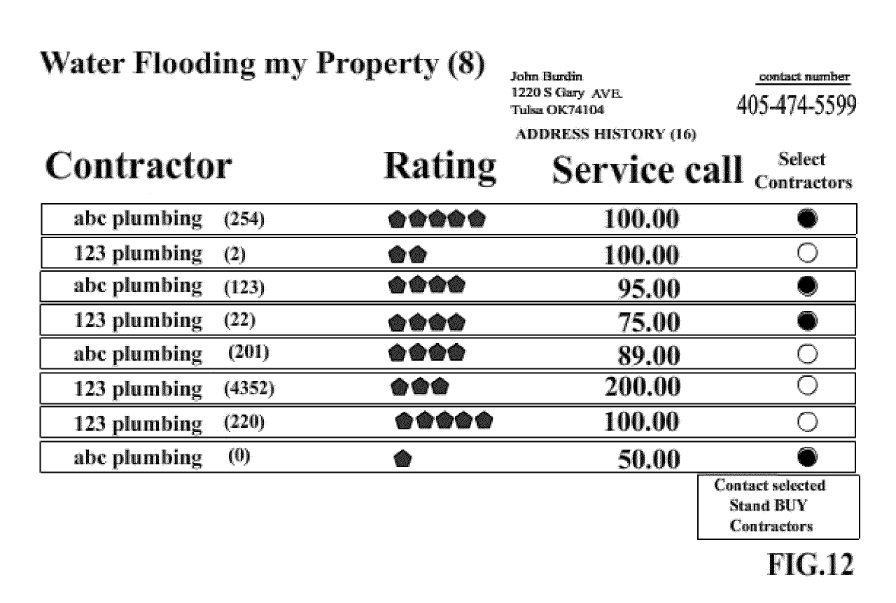

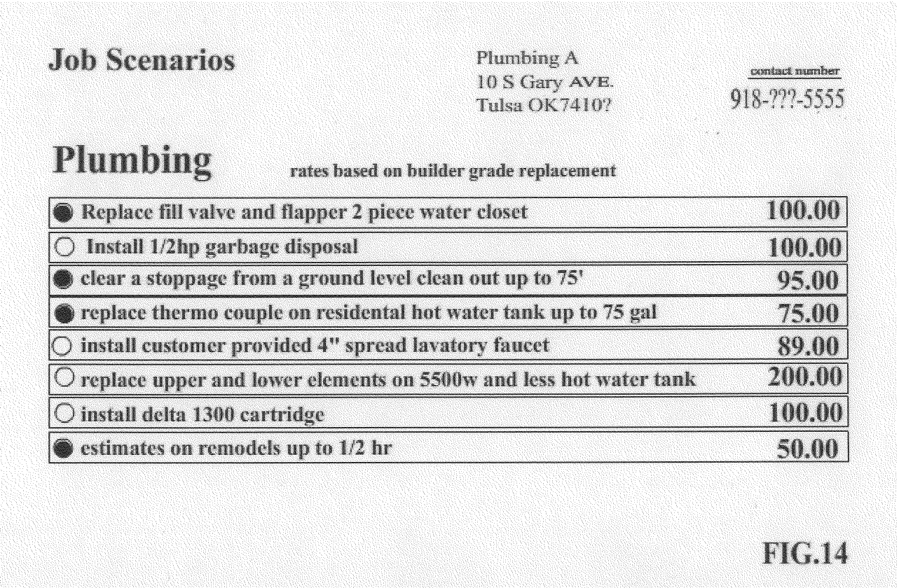

Referring now to FIG. 2, there is shown the vendor process portion of the method for using the system. The process starts at Box 100. The vendor can explore the site while not creating an account. Boxes 102,104,108 and 106 allow the vendor to learn about the site. Box 102 allows vendor to enter service area. Box 104 will bring the customer queue map as seen in FIG. 5 showing customer job work orders available. Box 110 allows the vendor to create an account. Vendor selects trades they offer. Vendor makes a company profile and technician resumes. Vendor profile will let vendors add the zip codes they wish to offer service too. Box 114 sets vendors' emergency scenario pricing checking scenarios they offer. On the scenarios checked vendor will fill in their prices as shown in FIG. 14. Vendor will then move to box 124. Box 124 allows vendor to check more scenarios. These scenarios will be of the non emergency type and often have more precise job criteria. Vendors will fill out all pricing on services offered by using a builder standard method on common service scenarios. This concludes the pricing portion of FIG. 2.

Box 116 allows vendor to enter the Standby Queue. Vendor will confirm he is available for immediate dispatch. This will move vendor to box 128. Box 128 has vendor in standby queue. As shown in FIG. 15 contractor will appear in list. Contractor moves up list as other vendors are hired. The system will require vendors in this queue to leave queue once they have contracted work and are not available for immediate dispatch.

Box 118 allows vendor to toggle on and off their scenarios and whether they wish to accept “name your own price” work orders. Box 126 is used to contact vendors of potential work. Vendors move to 130 to view work order and communicate with customer. Box 132 will require a code from customer to move work order from other vendors queue awarding the Work order to vendor with customer code. This moves work order to pending in box 140. Vendors can get to all open work orders from box 120. This allows vendors a dashboard of all open jobs. From here vendors can close cancel any pending work order which moves the work order to history box 136. This concludes this portion of vendor process.

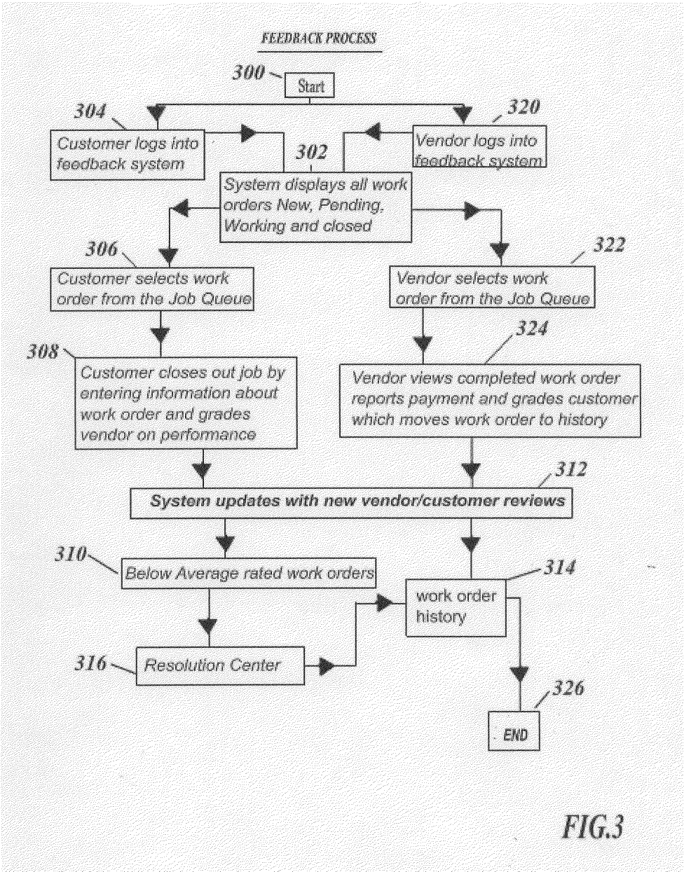

Although not specifically described in FIG. 2 when vendors create their profiles they may also purchase advertising from the system. For example vendor advertising is illustrated in the lower left hand corner of FIGS. 7 and 8. They also may purchase more space to attract customers to pick them with an upgraded profile section, etc. FIGS. 9 and 10 show the computer screens that are created from this information and which display the contractor and technician profile information for customers. The feedback scores that are displayed for the contractor and technicians are not part of the information that the vendor provides, but are a result of the feedback provided by customers, as will be more fully described hereafter in reference to FIG. 3.

Once the vendor has created profiles for their companies and technicians, then customers enter work orders as previously described in relationship to FIG. 1. As shown in box 104 of FIG. 2, the vendors then view the available jobs in the queue map within their service area, and as shown in box 118 the vendor solicits open work orders or responds to orders the customers have specifically requested that vendor to perform.

As described in box 132, the vendor contacts the customer and confirms the description and price of work to be performed. Although not specifically shown in the flow chart, if the customer chose to quote their own price for their work order, the vendor can respond by either accepting the customer's quoted price for the work or by providing the customer with a counteroffer price for the work until a job price is finally agreed upon by the vendor and customer. As shown in box 132, the vendor then performs the required service at the agreed upon rate and the service item is removed from the queue map. This ends the vendor process, as shown in box 160.

Referring now to FIG. 3, there is shown the customer feedback portion of the method for using the system. The process starts at box 300. Customers move to box 304 which allows customer to log in to feedback. Box 302 shows all open work order associated to customer account. Customer picks the work order they wish to complete in box 306. Box 308 of FIG. 3 allows the customer an area to grade vendor on work performed including cost and performance. This moves the work order to box 312. If the work order grade average or above the work order moves to box 314 which archives job in history status. If the work order grade below average it moves to box 310. Box 310 allows customer to state problem and desired solution if applicable moving work order to box 316 where work order awaits response from vendor moving customer to box 326 ending this portion of the feedback system.

Refer now to FIG. 3, which demonstrates the vendor feedback portion of the method for using the system. This process starts at Box 300 and moves vendors to box 320. Box 320 of FIG. 3 allows the vendor to log in to the feedback system. Vendors move to box 302 which will allow vendors to view all open work orders associated with their account, and then the vendor selects completed work order from queue and moves to box 324. In box 324 vendor can close out his side of work order. This area will be designed to help vendor follow up with every job they generate. They will add invoice number, type of payment, completion date and any explanations where applicable. Box 312 of FIG. 3 updates the feedback system and moves job to history when both customer and vendor feedbacks are complete. This moves to box 326 which ends this portion of the feedback process. Although not specifically described in FIG. 3 vendors and customers will be rewarded upon completion of successful completed feedback discounts for using service.

What is claimed is:

1. A self dispatching method for services comprising:
a vendor process portion where a vendor provides information on services and pricing into an internet based system and receives customer orders from the system in accordance with the pricing structure entered into the system, vendors without work may wait in a queue for next available customer
A customer process portion where a customer views information on vendors and pending orders and creates a customer profile, and then enters a work order for their job and a customer can view a list of available vendors and hire vendors for immediate service: then, a customer feedback portion where the customer provides information on the quality of the services provided by the vendor. Customers can name their own price, request the next available appointment, or select the vendor from a system database by job scenario that the system provides.

2. A self dispatching method for services according to claim 1, wherein the vendor process portion further encompasses;
creating a vendor profile in the system,
creating job scenarios based on builder grade materials,
viewing available jobs on a queue map in the system, soliciting open work and responding to specific work orders from the system, confirming with the customer the work and pricing prior to doing the work, performing the work at the agreed upon price, and removing the work order from the queue map.

3. A self dispatching method for services according to claim 2 wherein the customer process portion further comprises logging into the system, viewing a queue map in the system showing pending work orders in the customer's area based on their zip code, creating a work order in the system according to the customer's specific service requirements and selections, and validating the work order to the system so that the work order appears on the queue map in the system. The queue map is designed as an internet-based, dispatching method that offers customers real-time availability to service providers.

4. A self dispatching method for services according to Claim wherein customer feedback portion further comprises logging onto the system, entering validation code into the system for the work order, and providing feedback on work performed so that the system can update the vendor ratings appearing on the vendor and technician profile.

5. A self dispatching method for services that allows vendors¹ to wait in a queue list allowing customer a real time queue of available service providers in their service area.²
